(19) United States
(12) Patent Application Publication
(10) Pub. No.: US 2024/0396497 A1
(43) Pub. Date: Nov. 28, 2024

(54) SOLAR TRACKER VIBRATION ANALYSIS AND HEALTH MONITORING

(71) Applicant: Nextracker LLC, Fremont, CA (US)

(72) Inventors: Yang Liu, Mountain View, CA (US); David E. Kresse, Walnut Creek, CA (US); Chennan Li, Newark, CA (US)

(21) Appl. No.: 18/669,686

(22) Filed: May 21, 2024

Related U.S. Application Data
(60) Provisional application No. 63/468,218, filed on May 22, 2023.

(51) Int. Cl. H02S 50/00; G01S 3/78; G01S 3/786; H02S 20/32

(52) U.S. Cl. CPC H02S 50/00; G01S 3/7803; G01S 3/7861; H02S 20/32

(57) ABSTRACT

A method and system of analyzing health of a solar tracker, including confirming solar tracker is in a starting position, driving solar tracker through a range of angles, collecting data regarding performance of solar tracker, analyzing the collected data, and presenting one or more aspects of the collected data on a user interface indicating the health of the solar tracker.

### RELATED APPLICATIONS

This application claims the benefit of U.S. Provisional Patent Application No. 63/468,218, filed May 22, 2023, the entire contents of which are incorporated herein by reference.

### FIELD

This disclosure is related to energy conversion systems. More particularly, this present disclosure is related to solar tracking systems and assessing the health of various aspects of the solar tracking system.

### BACKGROUND

With the increasing recognition of the environmental affects and associated costs of burning fossil fuels, solar energy has become an attractive alternative. Solar tracking systems track the trajectory of the sun to more efficiently capture radiation, which is then converted to electrical energy. Solar tracking systems, however, are subject to brutal environments not least being exposed to direct sunlight, wind stresses, blowing sand and grit. Further, as solar trackers have been developed, they are being placed in increasingly difficult terrain making their installations harder to accurately accomplish. As a result, there are instances where misalignments occur, and while the solar tracker remains usable it may be less efficient or experience wear and failure faster than a properly aligned solar tracker. Accordingly, there is a need for systems and methods for assessing the health of a solar tracker both at its initial installation and throughout its life.

### SUMMARY

One aspect of the disclosure is directed to a method of analyzing health of a solar tracker. The method also includes confirming solar tracker is in a starting position; driving the solar tracker through a range of angles, collecting data regarding performance of the solar tracker, analyzing the collected data. The method also includes presenting one or more aspects of the collected data on a user interface indicating the health of the solar tracker. Other embodiments of this aspect include corresponding computer systems, apparatus, and computer programs recorded on one or more computer storage devices, each configured to perform the actions of the methods and systems described herein.

Implementations of this aspect of the disclosure may include one or more of the following features. The method where the presented aspect indicates high friction in the solar tracker. The presented aspect indicates a motor fault. The presented aspect indicates a communications error resulting in the solar tracker not achieving a designed position. The presented aspect indicates a fault in a battery of the solar tracker. The presented aspects indicates that the solar tracker is vertically mis-aligned. The presented aspect identifies in which direction the solar tracker is mis-aligned. The presented aspect identifies that the solar tracker is stuck at a position. The presented aspect identifies a type of a slew drive employed on the solar tracker. The presented aspect compares data from a plurality of solar trackers to identify one of the plurality of solar trackers that is stuck at a position, operating erratically, or experiencing a mechanical failure. The presented aspect compares data from a plurality of solar trackers to assess a build quality of each of the plurality of solar trackers. The presented aspect identifies a direction of travel of the solar tracker in which the solar tracker experiences a mechanical or electrical health issue. The presented aspect compares data of the solar tracker in comparison to mean data of a plurality of solar trackers. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### BRIEF DESCRIPTION OF THE DRAWINGS

The following figures are used to illustrate embodiments of the present disclosure. In all the figures, the same label refers to the identical or a similar element.

FIG. 1A shows a solar tracker array including multiple solar trackers in accordance with the disclosure;

FIG. 1B is a simplified perspective view of a tracker apparatus configured with a plurality of solar modules in accordance with the disclosure;

FIG. 2 shows a solar tracking control and information system in accordance with one embodiment of the present disclosure;

FIG. 3 shows a method of assessing health of a solar tracker in accordance with the disclosure;

FIG. 4A is a plot of normal temperature measurements of a plurality of solar trackers in accordance with the disclosure;

FIG. 4B is a plot of ab-normal temperature measurements of a plurality of solar trackers in accordance with the disclosure;

FIG. 5A is a plot of change in angulation of a solar tracker over time in accordance with the disclosure;

FIG. 5B is a graph in accordance with one aspect of the disclosure;

FIG. 6A is a plot of angulation of a solar tracker over time depicting normal operation in accordance with the disclosure;

FIG. 6B is a plot of angulation of a solar tracker over time depicting ab normal operation in accordance with the disclosure;

FIG. 7A is a plot of battery voltage and motor current as the solar tracker changes angulation in accordance with the disclosure;

FIG. 7B is a plot of battery voltage and motor current as the solar tracker changes angulation in accordance with the disclosure;

FIG. 8A is a plot of voltage and current showing a crossing indicating a solar tracker is oriented in the positive direction in accordance with the disclosure;

FIG. 8B is a plot of voltage and current showing a crossing indicating a solar tracker is oriented in the negative direction in accordance with the disclosure;

FIG. 9 is a plot showing a potentially stuck solar tracker in accordance with the disclosure;

FIG. 10 is a plot of a plurality of solar trackers of FIG. 9 for comparative purposes in accordance with the disclosure;

FIG. 11 is a plot of a comparison of multiple solar trackers in accordance with the disclosure;

FIG. 12 is a plot of energy usage of a plurality of solar trackers in accordance with the disclosure;

FIGS. 13A-13C depict comparison graphs of energy usage of a solar tracker indicating the direction in which the solar tracker is experiencing health issues in accordance with the disclosure;

FIGS. 14A-D depict a plot of a solar tracker over multiple days, indicating that the solar tracker gets stuck at a certain position in accordance with the disclosure;

FIG. 14E depicts a plot of a solar tracker indicating a small jump in the solar tracker as it moves through its movements in accordance with the disclosure; and

FIG. 15 depicts a plot of the movement of a solar tracker as compared to a mean of all solar trackers in an array in accordance with the disclosure.

### DETAILED DESCRIPTION

This disclosure is directed to methods and systems for analyzing a solar tracker installation and the health of a solar tracker as it is being operated. By employing these methods a systematic analysis of solar tracker in an array can be made such that over a given period every solar tracker, and therewith the driving components of the solar tracker can be assessed. As the data is collected regarding the health of the components of the solar tracker trends can be analyzed and determinations can be made regarding the health of components. With this information, parts can be ordered and shipped to a site, maintenance can be scheduled, and undertaken in a manner that reduces the impact of the maintenance on the energy collection capabilities of the solar tracker and the solar array.

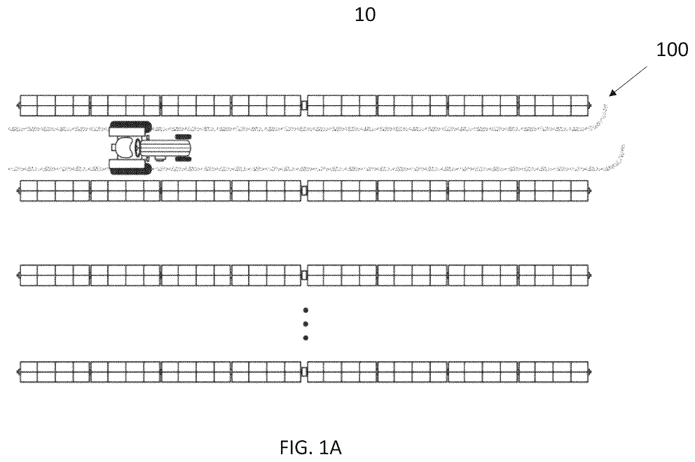

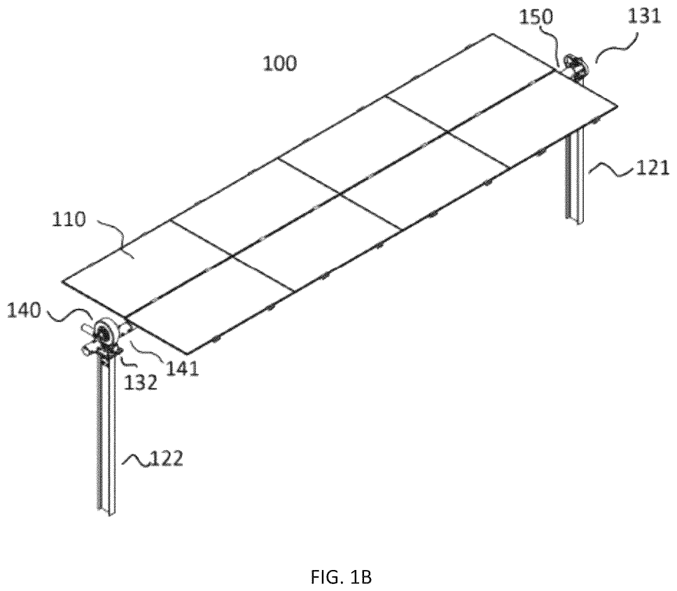

FIG. 1A is a top view of a solar array 10 composed of a plurality of solar trackers 100. As shown, the solar trackers 100 are separated by sufficient space to allow machinery to travel through the solar array between the solar trackers 100 to allow for cleaning and maintenance.

FIG. 1B is a simplified perspective view of a solar tracker 100 configured with a plurality of solar modules 110 according to the disclosure. A first pier 121 and the second pier 122 are two of a plurality of piers provided for the solar tracker 100.

The solar tracker 100 has a first pier 121 comprising a bearing 131 and a second pier 122 including a drive device 140 (e.g., a slew drive). The drive device 140 may have an off-set clamp device 141 or be directly coupled to a torque tube 150 operably disposed between the drive device 140 and the bearing 131. In an example, the cylindrical torque tube 150 comprises a one to ten inch diameter pipe made of Hollow Structure Steel (HSS) steel, however, other shapes including square, rectangular, D-shaped, and others may be employed without departing from the scope of the disclosure.

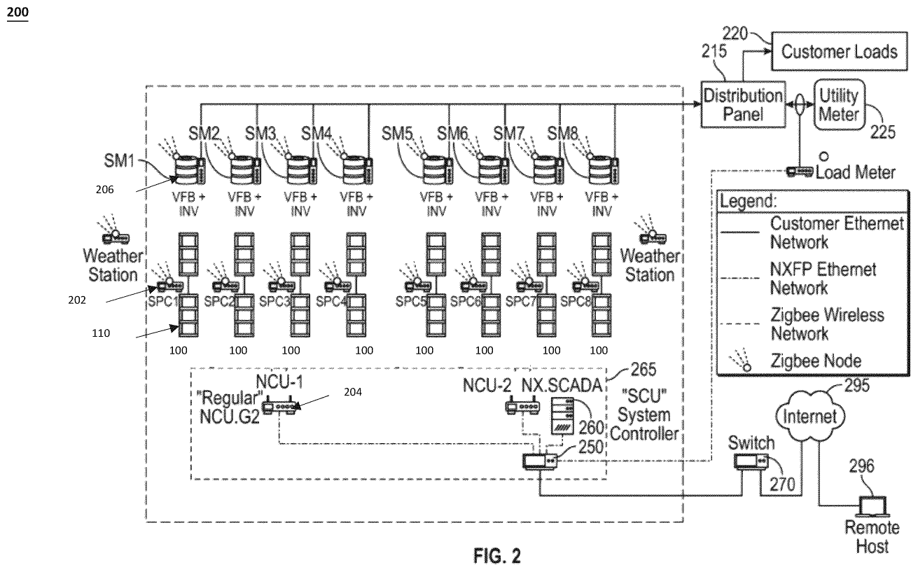

FIG. 2 shows a solar tracking control and information system 200 in accordance with one embodiment of the present disclosure. The solar tracking system 200 includes a distributed peer-to-peer network as described herein. The solar tracking system 200 includes multiple solar trackers 100, as note above each solar tracker 100 includes a plurality of solar modules 110 together forming an array 10 of solar trackers 100. Each solar tracker 100 is coupled to a corresponding self-powered controller (SPC) 202. Each SPC 202 includes a memory and stores therein logic for orienting its corresponding drive solar tracker 100 based on orientation commands. Those orientation commands may be stored locally in the memory on the SPC 202 or may be received for an external source such as a network control unit (NCU) 204. As one example, an SPC 202 receives an orientation command from an NCU 204 to orient a solar tracker 100 at an incident angle θi to the sun based on for example the date and the time of day. The drive device 140 receives commands from the SPC 202 to drive the solar tracker 100 to the angle θi. Each of the solar trackers 100 is able to be oriented independently of the other solar trackers 100.

Each solar tracker 100, and particularly the solar modules 110 receives light, converts the light into electricity, and stores the electricity in a corresponding storage medium (SM) 206. The storage media 206 are ganged together and electrically coupled through a distribution panel 215 to customer loads 220. The SMs 206 may be batteries, capacitors (e.g., super capacitors), flywheels, or other energy storage device. Network control units (NCU) 204 are each wirelessly coupled to one or more of the SPCs 202 (e.g., via bluetooth, Zigbee, or other wireless communication protocol). As shown in FIG. 1, NCU1 is wirelessly coupled to SPCs SPC1 to SPC4 and NCU2 is wirelessly coupled to SPCs SPC5 to SPC8. The NCUs 204 (NCU1 and NCU2) are both coupled over an Ethernet cable to an NXFP switch 250. The switch 250 couples NCU1 and NCU2 to a NX Supervisory Control and Data Acquisition (SCADA) 260, which in turn is coupled via a switch 270 to a remote host 296 over a network such as a cloud network 295. In some embodiments, the remote host 296 performs processing such as generating performance models as described herein and retrieving weather data. For ease of reference, the combination of NCU1, NCU2, NX SCADA 260 and NXFP switch 250 is referred to as an “SCU” system controller 265.

Each NCU 204 may also be coupled to each of the remaining NCUs, thereby forming a mesh architecture. Thus, if for any reason NCU1 loses communication to the SCADA 260, NCU1 can communicate with the SCADA 260 through NCU2. In other words, each NCU 204 acts as a gateway to the SCADA 260 for any other NCU 204. This added redundancy provides a fail-safe network. In one embodiment, the NCUs 204 are wirelessly coupled to each other.

Each NCU 204 has added functionality, for example they together ensure that the performance model is globally optimized and solar trackers 100 are operating properly. If, for example, an SPC 202 instructs an NCU 204 that it is shaded but, according to the performance model SPC 202 should not be shaded, the NCU 204 determines that an error has occurred. Each SPC 202 also informs its associated NCU 204 when it has changed its orientation. Using this information, the NCUs can thus keep track of the orientations of the solar trackers 100.

In accordance with one embodiment, if a solar tracker 100 suffers a communications failure and cannot communicate with its associated SCADA 260, the solar tracker 100 enters a default drive mode. As one example, in the default drive mode, a solar tracker 100 assisted by the SPC 202 and the logic stored therein and executed on a processor therein signals the drive device 140 to attempt to optimize the solar tracker's energy capture, for example by orienting the solar modules 110 such that they track the angle of the sun.

Each solar tracker 100 of FIGS. 1 and 2 include a battery system (not shown) that is employed to provide energy to drive the solar tracker 100 from east to west as it follows the sun. The battery is charged through the day either from the solar modules 110 of the solar tracker 100 or via a dedicated solar module (not shown) specifically for the purpose of charging the battery and providing the energy to drive device 140 to move the solar tracker 100. The flow of energy to and from the battery may also be analyzed and utilized, for example, to ensure that solar tracker 100 is accurately tracking the sun and to assess aspects of ambient conditions (e.g., cloud cover, shading, etc.). The battery, and particularly the flow of energy from the battery, can be analyzed to inform the user as to the health of the solar tracker 100 for example the health of the drive motor 140 or the bearing 131.

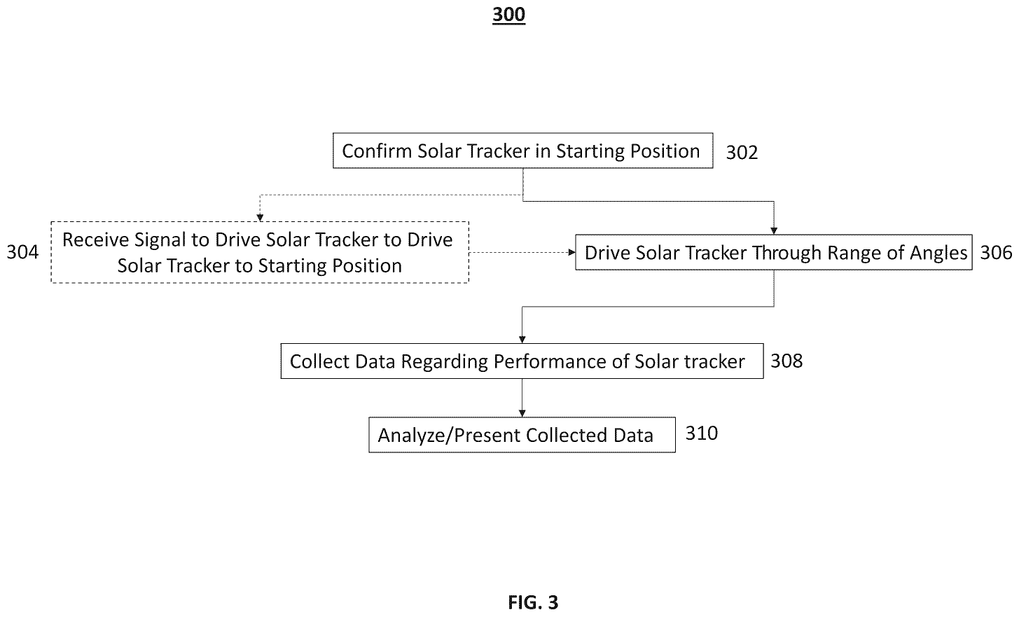

One aspect of the disclosure is directed to a method 300 as depicted in FIG. 3 for moving the solar tracker 100 and collecting a variety of data regarding the health of the solar tracker 100 and the components of the solar tracker 100. The method 300 is preferably a software program stored in a memory and executed by a processor on either the SCADA 260, the remote host 296, the NCUs 204 or the individual SPCs 202 to move the solar tracker 100. The method 302 starts with the SCADA 260, the remote host 296, the NCUs, or the SPCs 202 confirming that that the solar tracker 100 to a starting position at step 302. In one example, the starting position may be in the maximum westward orientation such as would be experienced at the end of the day. Alternatively, the starting position may be at a maximum eastward orientation such as would be experienced around sunrise to capture energy from the sun at sunrise. Or the starting position may be a 0-angle position where the solar tracker 100 is oriented such that the solar modules are in a substantially horizontal position. At step 304, if the solar tracker 100 is not at a starting position, a signal is received by the drive device 140 to drive the solar tracker 100 to the start position.

At step 306 a solar tracker 100 is driven from the starting position (e.g., and extreme westward orientation) through a range of angles. In one example, the solar tracker may be driven from a starting point at an extreme westward orientation to an extreme eastward orientation. As the solar tracker 100 is driven through the range of angles, a variety of data are collected regarding the performance of the solar tracker 100 at step 308. The primary data to be collected include the time of performance of the method 300, ambient temperature during performance of the method 300, temperature of the drive device 140 during step 306, time required to perform step 306, recorded positions during step 306, motor current of the drive device 140 and battery voltage during step 306, and orientation of the solar tracker during step 306. These data can then be analyzed at step 310 and output via for example a user interface operable on the remote host 296 for analysis.

In accordance with the disclosure, step 306 may be undertaken via a variety of different protocols. In a first protocol is a continuous sweep, where the solar tracker 100 is driven without stopping from the starting position (e.g., an extreme westward orientation) to a stopping position (e.g., an extreme eastward orientation), as will be appreciated, other portions of the operating range of the solar tracker 100 may be utilized without departing from the scope of the disclosure. In a second protocol, rather than continuous sweep, a stepwise sweep of the solar tracker 100 may be undertaken. The steps can be any number of degrees (e.g., 1, 2, 5, 10, 15, 20, 25, 30, etc.). By conducting a stepwise sweep, the starting torque at each position may be assessed. The torque required to put the solar tracker 100 in motion from a stopped position is typically greater than need to continue an existing motion. Such data may reveal points in the motion of the solar tracker 100 experiencing greater friction, as might be the result of a failing bearing or an issue with a winding of the drive device 140. In some instances, for example where historical data suggests that a portion of the range of operation for that specific solar tracker 100 may be of concern the continuous sweep or stepwise sweep may be undertaken over just that range. As an example, where a portion of the rotational range of the solar tracker experiences high driving current for the drive device 140 may represent a portion of the operational range of the solar tracker 100 that should be regularly checked to determine if the condition is progressing or has progressed to a point where corrective action needs to be taken.

In addition to capturing the data from the method 300 related to a dedicated health assessment of the solar tracker 100, data may be collected during normal operation of the solar tracker 100. This data can be collected by the SPC 202, transmitted to the NCUs 204 and other computing elements (e.g., remote host 296) of the system 200 to store and analyze the data to provide alerts and determine whether and when remedial actions are necessary.

Both in connection with the method 300 or the collection of data during normal operation, another aspect of the disclosure relates to the data capture rate. As will be appreciated, the SPC's 202 may have limited memory capacity. Thus, the measured data (e.g., driving current) may only be captured at a particular rate (e.g., once per minute) during the normal movement of the solar tracker 100. As will be appreciated, the data capture rate may be adjusted for particular portions of the operational range of the solar tracker 100 (e.g., to once per second) to develop high resolution data for that portion of the operating range.

As noted above, each NCU 204 is in communication with a plurality of (e.g., up to 100) SPCs 202. As this communication is typically conducted using a wireless communication protocol (e.g., Bluetooth or Zigbee) the communications between an individual SPC 202 and its NCU 204 are scheduled. In connection with the changing of the data capture rate, the NCU 204 may adjust the data capture rate of the SPC 202 and also the frequency of the communications of with individual SPCs 202. The NCU 204 may select one or more of the SPCs 202 to have their communications rate or their data collection rate adjusted.

Another aspect of the disclosure relates to the NCU 204 directing the SPC 202 to perform the method 300. As will be apparent the array because there are so many solar trackers 100 in the array that only a few may be driven through the assessment method 300 during a single nighttime period. In some embodiments the method 300 requires 15-30 minutes to complete, thus in a given nighttime operation, even one where there are 12 hours of darkness during which to perform the method, only 24-48 solar trackers can be assessed. In instances where the array contains 400-500 such trackers, performance of the method may only occur once every 10 days or so. However, utilizing the methods described herein regular assessment of the health of the individual solar tracker 100 can be captured and compared to its historical trends. As will be appreciated, as a tracker 100 starts to show an issue the frequency at which that solar tracker 100 is assessed may be changed to ensure that the issues have not progressed to a point where the solar tracker should be taken out of service, and maintenance can be scheduled appropriately.

The software program, executing method 300 may include an analytical component that reviews the data collected and assessing the data for indicators of the health of the solar tracker 100. This may be as part of a user interface for example on the remote host 296. Where an issue is determined to exist, the software program may generate an error signal, transmitted to, for example, the remote host 296 alerting one or more of an operator, owner, builder, etc., that a potential mechanical or electrical issue has been uncovered. Further, the software may categorize the issue in a variety of manners including, requires immediate attention, part of trend data that will require attention and may be planned for, and normal operation. Those of skill in the art will recognize that there are an infinite variety of methods of displaying and categorizing the data to make the data useful. In other instances, the collected data is stored locally or in the cloud.

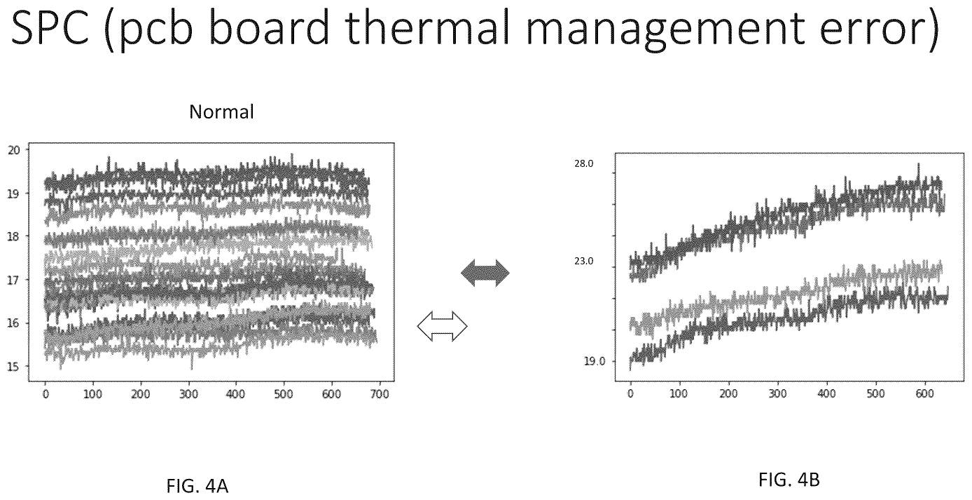

FIG. 4A-15 depict graphical representations of a variety of data that can be collected by the SPCs 202 and analyzed as described herein. FIG. 4A depicts the output of a thermal sensors mounted on a printed circuit boards in the SPCs 202 which are mounted proximate drive device 140 on the solar tracker and powered by the battery. In FIG. 4A the thermal sensor holds substantially constant through out the driving of the solar tracker 100 during step 306. In FIG. 4B some of the outputs from the thermal sensors are missing, and those that are present show a rising temperature being sensed during step 306. As the method 300 is likely (though not necessarily exclusively) to be performed at night, when temperature generally remain constant or would be expected to be dropping, a rising sensed temperature from the temperature sensors likely indicate either a communications issue with the SPC 202, a thermal management issue for the SPC 202, or a heavy current draw for the drive device 140.

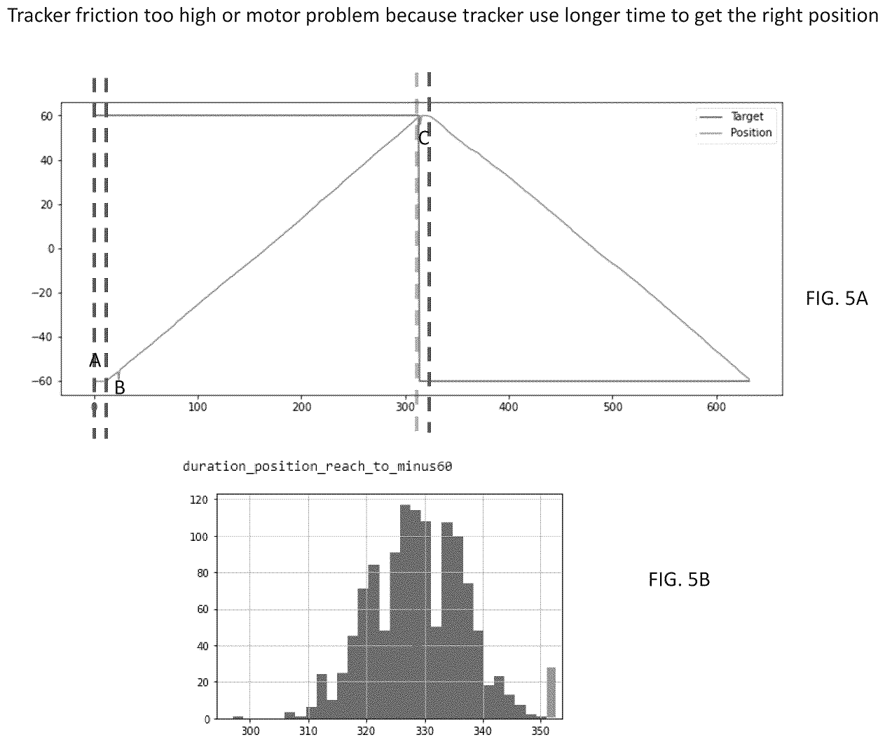

FIG. 5A depicts a graph of solar tracker 100 angle through step 306 compared to the time required to achieve that angle of orientation. As can be seen, there is an offset of some time to reach the 60-degree orientation from the starting point of the −60-degree position. This is then magnified on the return to the −60-degree position. The increase in time over the expected time can be attributed to excess friction in the solar tracker 100 (e.g., at one of the bearings of the solar tracker), or it could be indicative of an issue with the drive device 140 itself.

The excess friction can be observed in multiple points in the graph of FIG. 5A. An initial indicator of friction can be seen by the flatness of the curve at point A. This flatness indicates that for this time-period that the orientation of the solar tracker 100 has not changed indicating high friction that the drive device 140 is experiencing prevents movement of the solar tracker 100. At point B, the curve of the change in position of the solar tracker 100 experiences a sharp change. This sharp change at point B may indicate either a point in the movement of the solar tracker 100 of either high friction or another issue with or fault in the drive device 140. A similar sharp change is observed in the graph at point C. The result of these friction points A, B, C (or fault points) is that the time required to transition the solar tracker 100 from −60-degree position and to return to the −60 degree position is greater than expected and is unbalanced, requiring more time to transition from −60-degree position to the 60-degree position than the reverse movement from the 60-degree position to the −60-degree position.

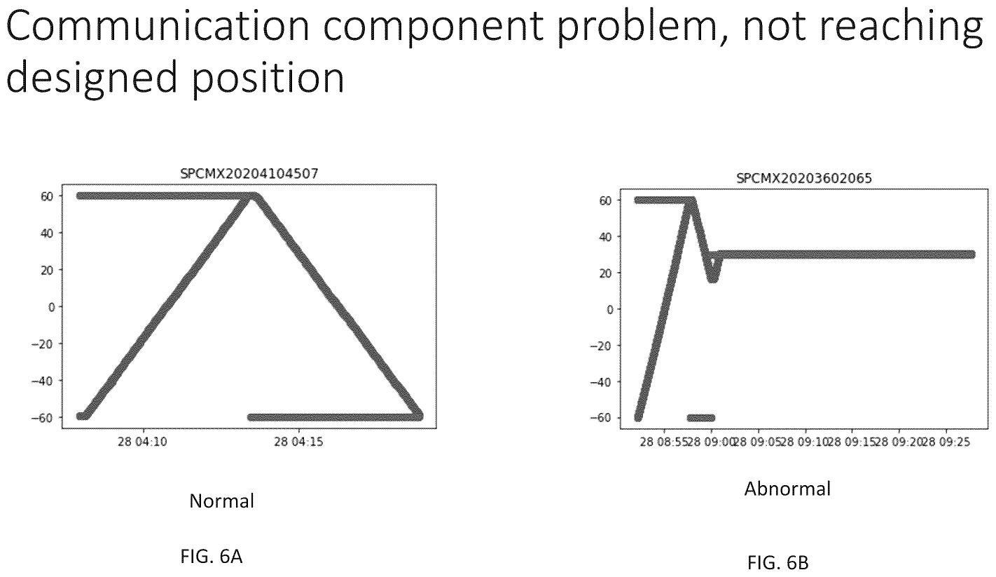

FIGS. 6A and 6B depict similar graphs to that of FIG. 5A. In FIG. 6A the angled line depicts the movement of the solar tracker as it moves from a −60-degree position to a 60-degree position. In FIG. 6A, the movement is symmetrical and reaches the desired positions. In contrast in FIG. 6B there is asymmetrical movement, and the solar tracker never regains the −60-degree position. This failure to achieve the designed return position is likely the result of a communications error caused by a failure within, for example, the SPC 202 for that solar tracker.

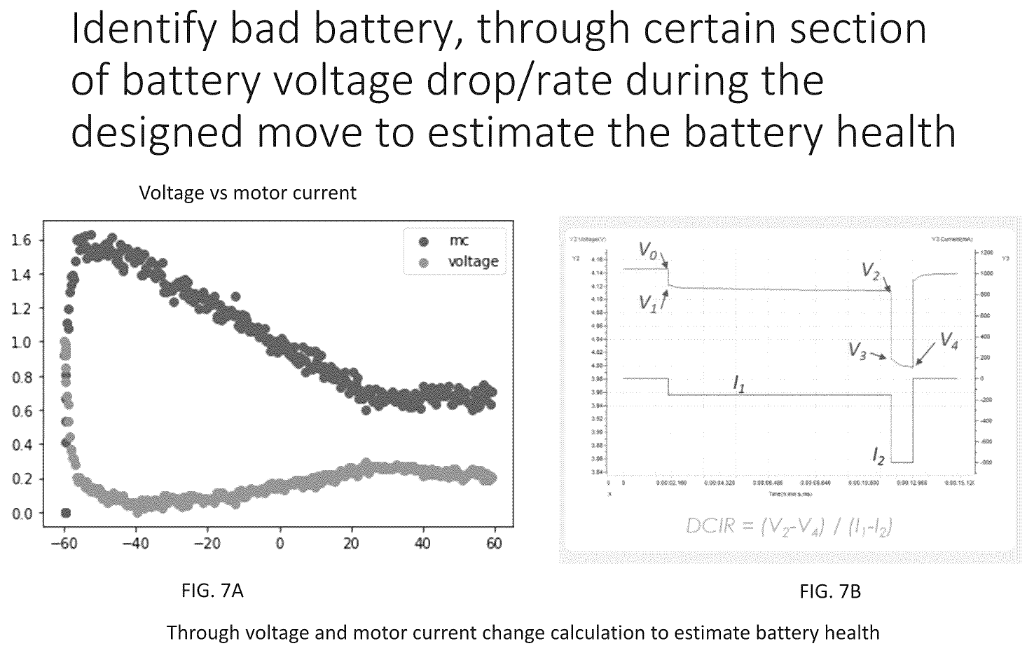

FIGS. 7A and 7B depict two graphs of the motor current drawn by the drive device 140 and the voltage. FIG. 7A depicts an expected change in voltage and motor current the solar tracker 100 goes through the progression from the −60-degree position to the 60-degree position with high initial motor currents needed to overcome inertia steadily dropping and then beginning to rise again as the tracker 100 approaches the 60-degree position. The voltage follows a substantially reciprocal plot. FIG. 7B depicts an analysis of a voltage and current of a battery supplying energy to the drive device 140. By analyzing the voltage drop through a portion of the movement of the solar tracker 100 a determination of battery health for that solar tracker 100 can be made. Where the voltage drop compared to the current drop exceeds a predetermined value, the health of the battery can be determined to be sufficiently poor, or to be experiencing a fault sufficient to require replacement.

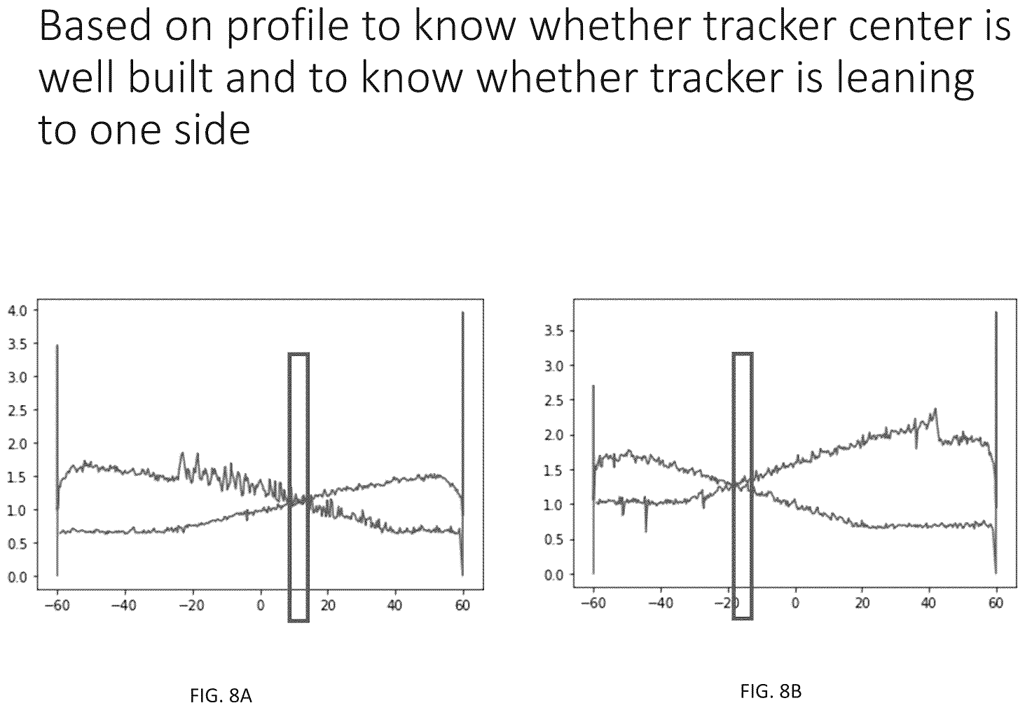

FIGS. 8A and 8B depict an analysis of an installation of a solar tracker 100. As can be seen in FIG. 8A there are plotted the motor current vs. voltage to drive solar tracker 100. These plots have a crossing point A. That crossing point corresponds to the point in the movement from the −60-degree position to the 60-degree position at which the solar tracker 100 has moved to its balance point. As designed this balance point should be at the 0-degree position with the solar panels arranged in a substantially horizontal position. However, as the solar trackers 100 are being installed there are at times imperfections in the installation. FIG. 8A depicts an installation where the balance point is reached at about 12 degrees, whereas FIG. 8B depicts a balance point of about-17 degrees. This knowledge is important in the analysis of the performance of the solar tracker 100 and informs how to interpret data, such as the data of FIGS. 7A and 7B. The vertical misalignment of the solar tracker 100 impacts both how it operates, and the energy profile required to drive the solar tracker 100 through its rotation. In addition, this misalignment can impact the wear of elements of the solar tracker 100 over the life of the solar tracker 100.

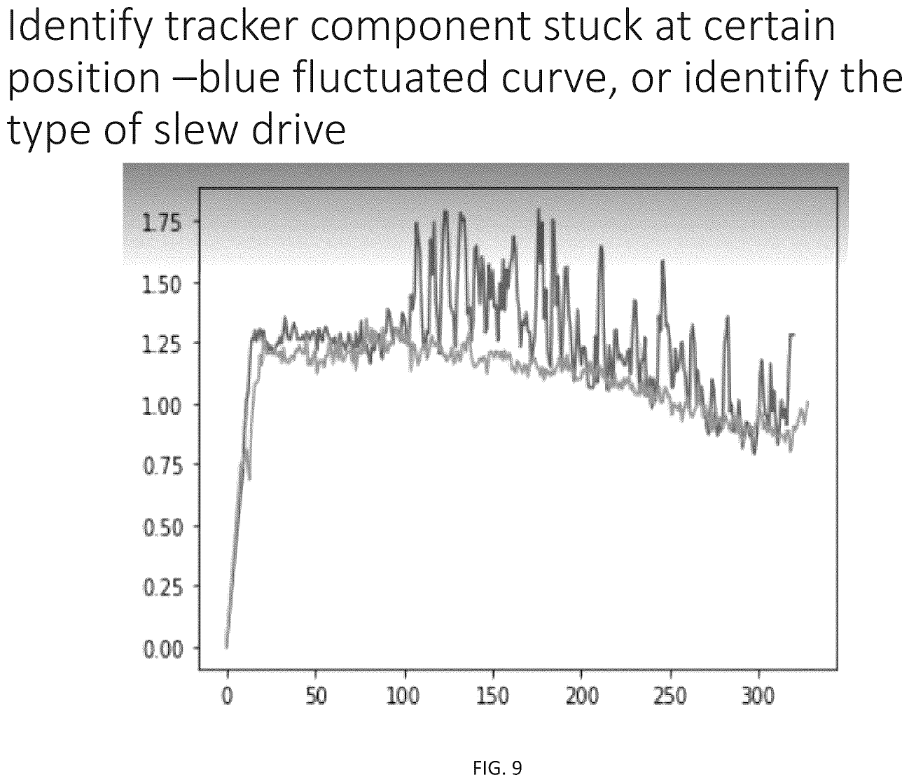

FIG. 9 depicts yet another plot of the current of the drive device 140 over time compared to an expected plot. By having a wildly fluctuating plot as opposed to the relatively smooth curve, a determination can be made that the solar tracker 100 may be experiencing ticking (e.g., very high friction) at points as it is being driven by the drive device 140.

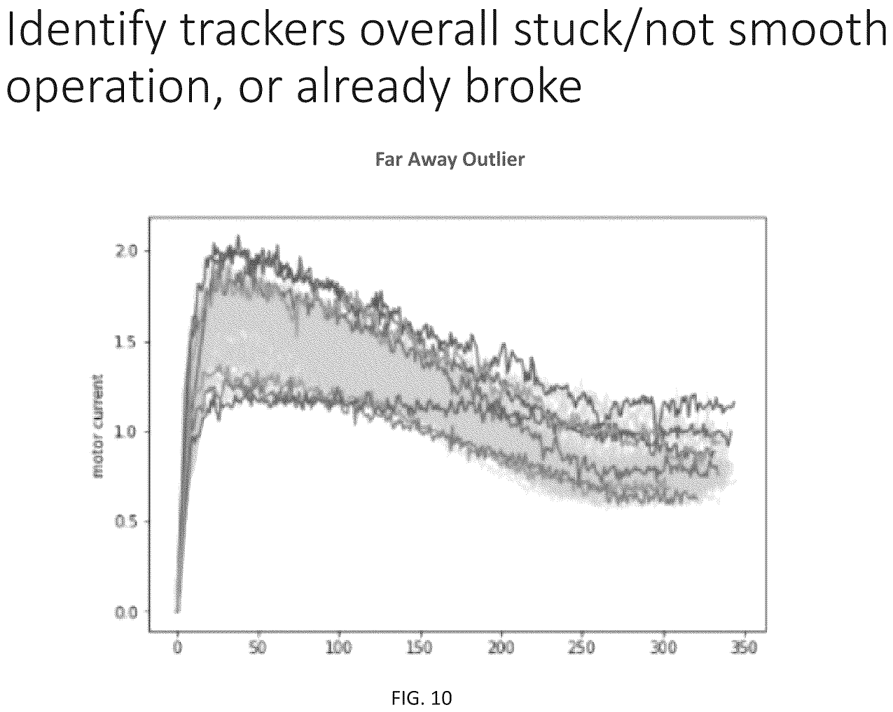

FIG. 10 depicts a similar graph to that of FIG. 9; however, FIG. 10 shows the plot of several solar trackers 100 to allow for graphic and immediate comparison of multiple solar trackers. This plot in FIG. 10 may depict a solar tracker 100 that is stuck or not operating smoothly, operating erratically, or even one that has entirely ceased operation for some reason.

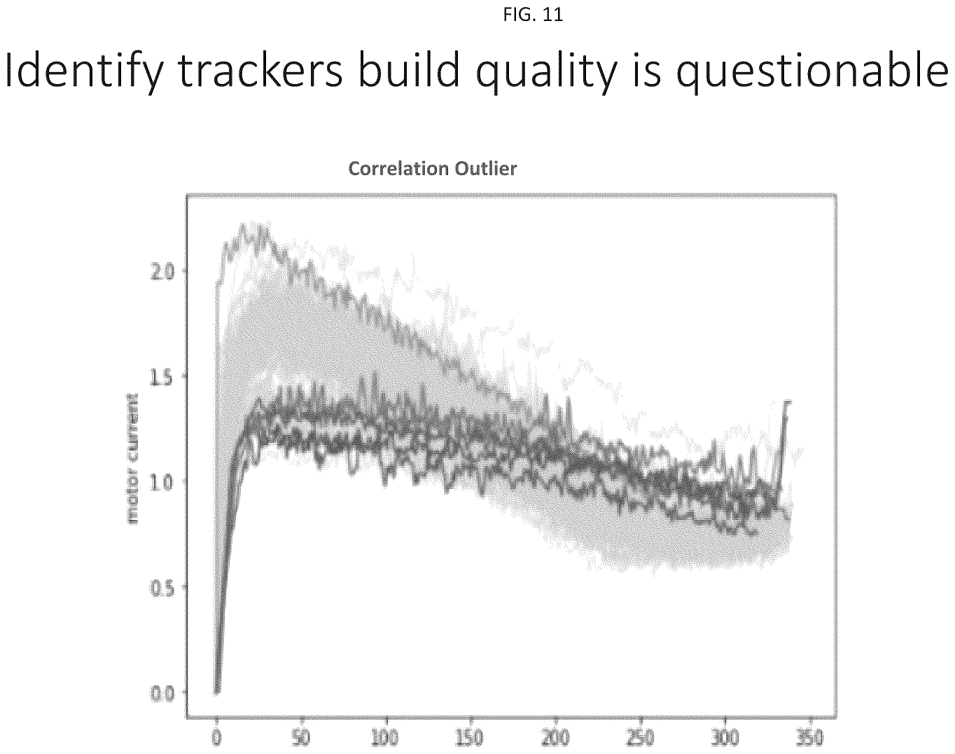

FIG. 11 provides another similar plot as FIG. 10, however the plot of FIG. 11 may be employed during the commissioning of the solar trackers 100 to demonstrate that all are within acceptable bounds for operation indicating a successful and accurate construction. Alternatively, the plot may indicate that one or more of the solar trackers 100 has been incorrectly installed and also providing a baseline for future measurements for comparison and assessment during the life of the solar trackers 100.

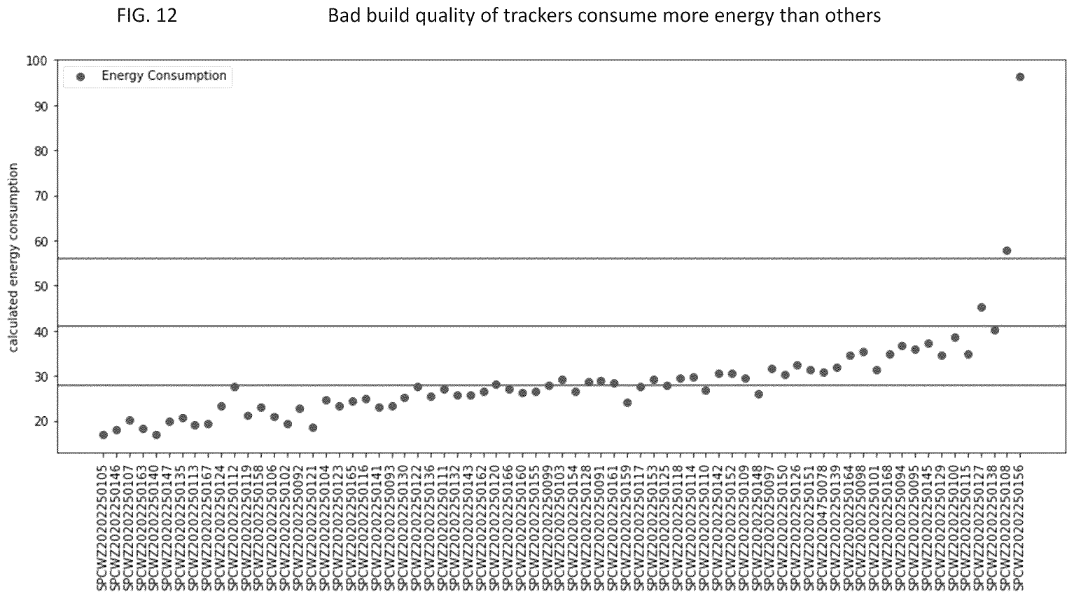

FIG. 12 depicts a plot of the energy consumption of a plurality of solar trackers having gone through the exercise of method 300. As can be seen each solar tracker 100 has its own unique power consumption, however, two solar trackers have an energy consumption that signals either a mechanical failure (e.g., motor winding, bearing failure, etc.) or if this is an initial operation as might be the case in a commissioning scenario, the energy consumption can indicate poor build quality of the two solar trackers 100 as compared to the rest of the array. These may need to be brought within tolerance before the array can be fully commissioned and handed over to the operator.

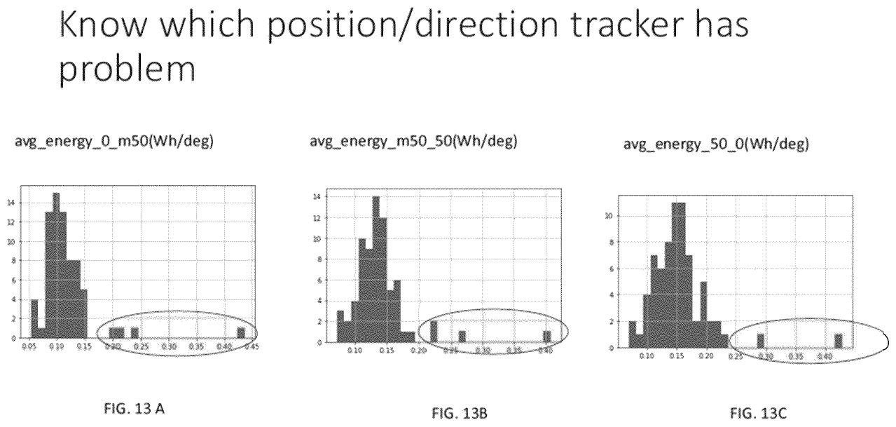

FIG. 13A-13C depict a graph of the average energy used by three solar trackers 100. While the initial starting energy required to initiate movement and overcome inertia is expected, the circled portions of the graphs depict portions of the movement and in which direction there are perceived issues with the solar trackers 100.

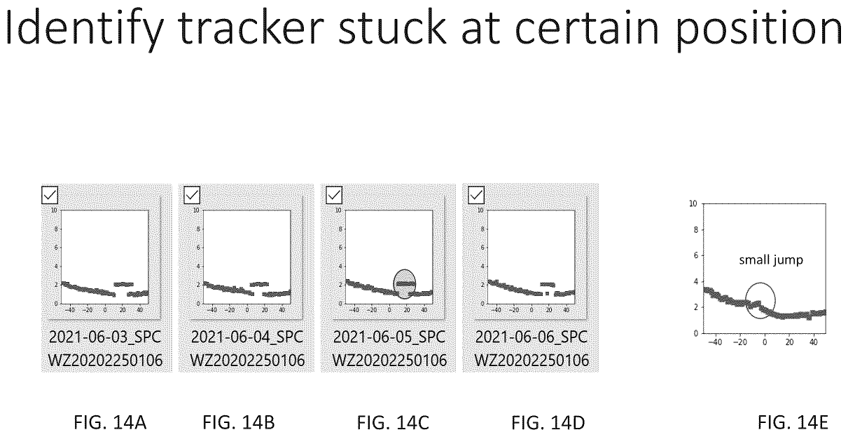

FIGS. 14A-14D depict the current plots of a solar tracker 100 over the course of four days. In each graph, a similar gap is seen in each current plot, and at each gap the current for the solar tracker is increased for a portion of the movement. This increased current that occurs each day at about the same point is thus indicative of the tracker becoming stuck and requiring more energy to continue its movement. In a similar fashion FIG. 14E depicts an instance where the increase in power is smaller but still observable as a small jump. Analysis of these plots may be useful in assessing the health of the solar tracker over the course of a longer duration (e.g., months and years) to determine when the known issues have reached a point where they require maintenance.

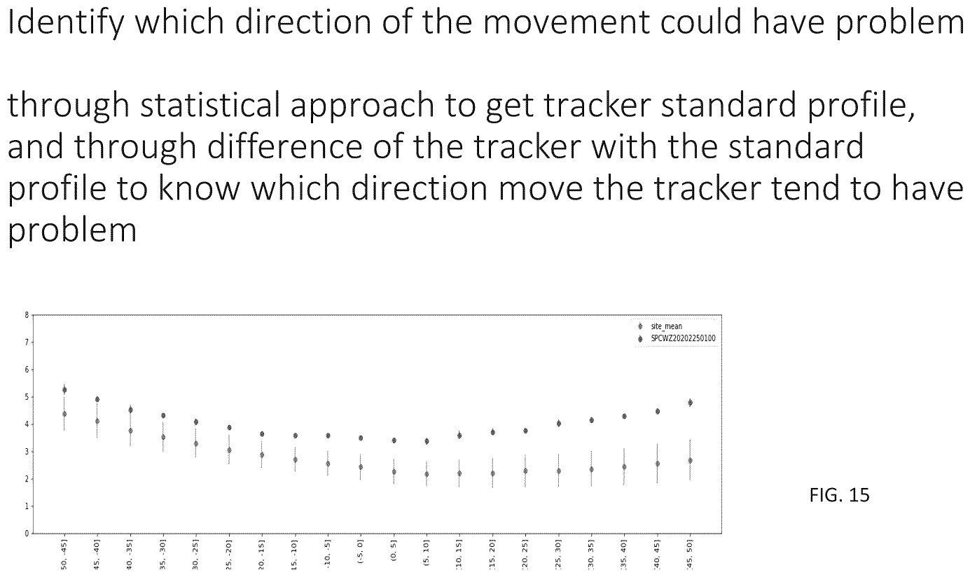

FIG. 15 depicts a statistical plot showing an upper plot of the power required move the solar tracker 100 at each 5 degrees as the solar tracker 100 moves from a −50-degree position to a 50-degree position. The lower plot is the mean power required by all of the solar trackers 100 of a site. As can be seen, this particular solar tracker 100 requires at all points greater energy than the site mean. That alone is not dispositive of an issue with the solar tracker 100, since half of all members of the site will have greater energy demands than the mean and half will have power demands below the mean. However, what does signal a potential issue of the specific solar tracker 100 is the divergence from the mean as that is inconsistent from about the 10-degree position to the 50-degree position. In this manner, the solar tracker 100 having some potential mechanical issues can be identified, the magnitude of the potential issue can be assessed, and the direction of travel of the solar tracker 100 where the potential issue can be found. This data can be useful when further diagnostics are performed to assess the health of the solar tracker 100.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of embodiments. Those skilled in the art will envision other modifications within the scope and spirit of the claims appended hereto.

1. A method of analyzing health of a solar tracker, comprising:
confirming solar tracker is in a starting position;
driving the solar tracker through a range of angles;
collecting data regarding performance of the solar tracker;
analyzing the collected data; and
presenting one or more aspects of the collected data on a user interface indicating the health of the solar tracker.

2. The method of claim 1, wherein the presented aspect indicates high friction in the solar tracker.

3. The method of claim 1, wherein the presented aspect indicates a motor fault.

4. The method of claim 1, wherein the presented aspect indicates a communications error resulting in the solar tracker not achieving a designed position.

5. The method of claim 1, wherein the presented aspect indicates a fault in a battery of the solar tracker.

6. The method of claim 1, wherein the presented aspects indicates that the solar tracker is vertically mis-aligned.

7. The method of claim 6, wherein the presented aspect identifies in which direction the solar tracker is mis-aligned.

8. The method of claim 1, wherein the presented aspect identifies that the solar tracker is stuck at a position.

9. The method of claim 1, wherein the presented aspect identifies a type of a slew drive employed on the solar tracker.

10. The method of claim 1, wherein the presented aspect compares data from a plurality of solar trackers to identify one of the plurality of solar trackers that is stuck at a position, operating erratically, or experiencing a mechanical failure.

11. The method of claim 1, wherein the presented aspect compares data from a plurality of solar trackers to assess a build quality of each of the plurality of solar trackers.

12. The method of claim 1, wherein the presented aspect identifies a direction of travel of the solar tracker in which the solar tracker experiences a mechanical or electrical health issue.

13. The method of claim 1, wherein the presented aspect compares data of the solar tracker in comparison to mean data of a plurality of solar trackers.

14. A method of analyzing health of a solar tracker, comprising:
driving the solar tracker through a range of angles;
collecting data regarding performance of the solar tracker;
analyzing the collected data; and
presenting one or more aspects of the collected data on a user interface indicating the health of the solar tracker, the presented aspect including identifying that the solar tracker is stuck at a position.

15. The method of claim 14, wherein the presented aspect indicates a fault in a battery of the solar tracker.

16. The method of claim 14, wherein the presented aspects indicates that the solar tracker is vertically mis-aligned.

17. The method of claim 16, wherein the presented aspect identifies in which direction the solar tracker is mis-aligned.

18. A method of analyzing health of a solar tracker, comprising:
driving the solar tracker through a range of angles;
collecting data regarding performance of the solar tracker;
analyzing the collected data, the analyzing including comparing data from a plurality of solar trackers to identify one of the plurality of solar trackers that is stuck at a position, operating erratically, or experiencing a mechanical failure; and
presenting one or more aspects of the collected data on a user interface indicating the health of the solar tracker, the presented aspect including identifying that the solar tracker is stuck at a position.

19. The method of claim 18, wherein the analyzing the collected data includes comparing data from a plurality of solar trackers to assess a build quality of each of the plurality of solar trackers.
